(19) United States
(12) Patent Application Publication
(10) Pub. No.: US 2026/0106100 A1
(43) Pub. Date: Apr. 16, 2026

(54) Contactor Yoke and Contactor

(71) Applicants: Tyco Electronics (Shanghai) Co., Ltd., Shanghai (CN); Tyco Electronics Technology (SIP) Co., Ltd., Suzhou (CN)

(72) Inventors: Lulu (Steven) Zhou, Suzhou (CN); Zesheng Jiang, Suzhou (CN); Kevin (Xujia) Wang, Suzhou (CN); Quarry (Bingfeng) Qu, Suzhou (CN); Lizhong Wang, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/357,673

(22) Filed: Oct. 14, 2025

(30) Foreign Application Priority Data
Oct. 15, 2024 (CN) 202422489367.6

(51) Int. Cl. H01H 50/60; H01H 9/38; H01H 9/44; H01H 50/14; H01H 50/44; H01H 50/58; H01H 50/64

(52) U.S. Cl. CPC H01H 50/60; H01H 9/38; H01H 9/44; H01H 50/14; H01H 50/44; H01H 50/58; H01H 50/641

(57) ABSTRACT

A contactor yoke, includes a pair of side plates and a bottom plate. Each side plate has an upper part and a lower part. Each side plate has an upper buckle structure formed on the upper part and a lower buckle structure formed on the lower part. The bottom plate is connected between a bottom of each of the pair of side plates. Each upper buckle structure buckles onto an upper housing of a contactor to fix the contactor yoke and a magnetic plate of the contactor together to the upper housing. Each lower buckle structure buckles to a lower housing of the contactor to fix the contactor yoke to the lower housing.

### CROSS-REFERENCE TO RELATED APPLICATION

This application claims the benefit of the filing date under 35 U.S.C. § 119(a)-(d) of Chinese Patent Application No. 202422489367.6, filed on Oct. 15, 2024.

### FIELD OF THE INVENTION

The present invention relates to a yoke and, more particularly, to a contactor yoke and a contactor comprising the contactor yoke.

### BACKGROUND OF THE INVENTION

A contactor typically includes a housing, a pair of static terminals, a movable terminal, a yoke, a magnetic plate, and a coil assembly. The housing includes an upper housing and a lower housing assembled together. A pair of static terminals are fixed to the top wall of the upper housing and extend into the arc extinguishing chamber of the upper housing. The movable terminal is set in the arc extinguishing chamber of the upper housing, and can move between a closed position in electrical contact with a pair of static terminals and an open position in electrical separation from the pair of static terminals. The yoke and magnetic plate are installed in the lower housing to form the magnetic circuit of the contactor. The coil assembly is set in the yoke. The coil assembly includes a coil skeleton and a coil wound around the coil skeleton.

The upper part of a pair of side plates of the yoke is riveted to the magnetic plate through four riveting plates, so that the yoke and the magnetic plate are fixed together. The bottom of the yoke is glued to the bottom wall of the lower housing or the bottom of the yoke is not fixed. The existing riveting and adhesive bonding schemes have defects such as complex processes, high costs, unreliable fixation, time-consuming and labor-intensive processes, and low production efficiency.

### SUMMARY OF THE INVENTION

A contactor yoke includes a pair of side plates and a bottom plate. Each side plate has an upper part and a lower part. Each side plate has an upper buckle structure formed on the upper part and a lower buckle structure formed on the lower part. The bottom plate is connected between a bottom of each of the pair of side plates. Each upper buckle structure buckles onto an upper housing of a contactor to fix the contactor yoke and a magnetic plate of the contactor together to the upper housing. Each lower buckle structure buckles to a lower housing of the contactor to fix the contactor yoke to the lower housing.

### BRIEF DESCRIPTION OF DRAWINGS

The invention will now be described by way of example with reference to the accompanying figures, of which:

FIG. 1 is a perspective view of a contactor according to an exemplary embodiment;

FIG. 2 is a cross-sectional view of the contactor of FIG. 1;

FIG. 3 is a perspective view of a contactor yoke and a magnetic plate of the contactor of FIG. 1;

FIG. 4 is a perspective view of the contactor yoke of FIG. 3;

FIG. 5 is a cross-sectional view of the contactor of FIG. 1, where an upper pin and a lower pin of the contactor yoke of FIG. 3 are shown;

FIG. 6 is a partial exploded view of the contactor of FIG. 1;

FIG. 7 is a partial exploded cross-sectional view of the contactor of FIG. 1; and

FIG. 8 is another partial exploded cross-sectional view of the contactor of FIG. 1.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

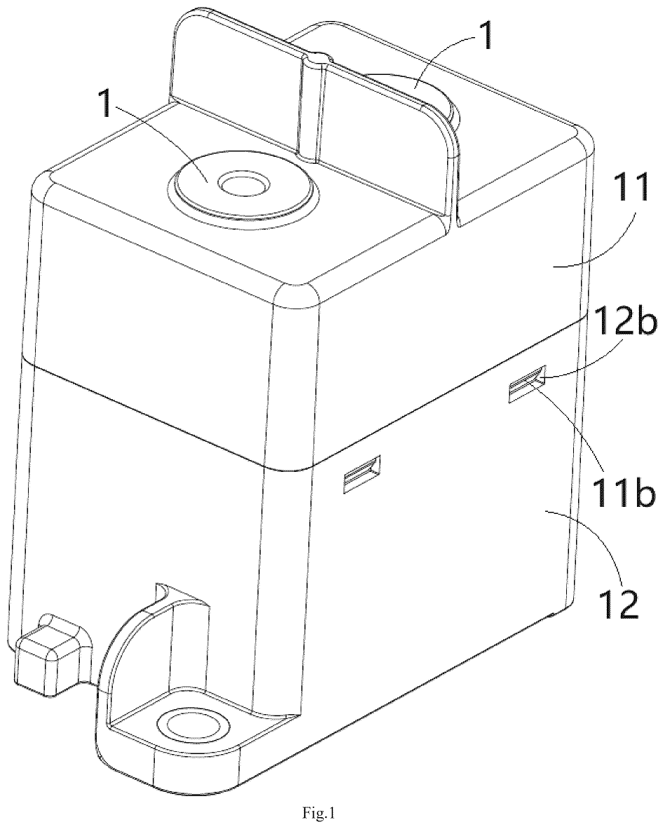

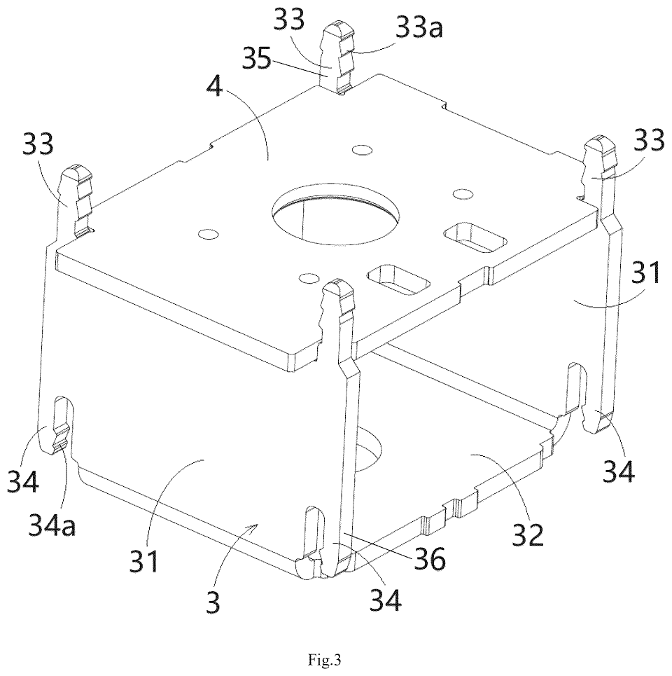

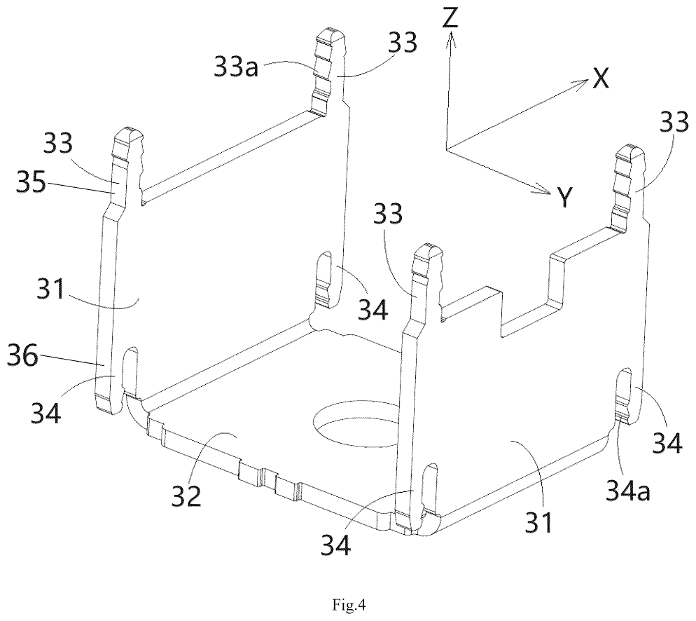

An exemplary embodiment of a contactor yoke 3 will now be described with reference to FIGS. 1-8. As shown in FIGS. 3-4, the contactor yoke 3 includes a pair of side plates 31 and a bottom plate 32. An upper buckle structure 35 and a lower buckle structure 36 are respectively formed on an upper part and a lower part of the pair of side plates 31. The bottom plate 32, as shown in FIGS. 3-4, is connected between the bottom of the pair of side plates 31. The upper buckle structures 35 of the pair of side plates 31 are used to buckle to the upper housing 11, as shown in FIGS. 1-2 and 5-8, of the contactor, to fix the contactor yoke 3 and the magnetic plate 4 of the contactor together to the upper housing 11. The lower buckle structures 36 of the pair of side plates 31 are used to buckle to the lower housing 12, as shown in FIGS. 1-2 and 5-8, of the contactor, in order to fix the contactor yoke 3 to the lower housing 12.

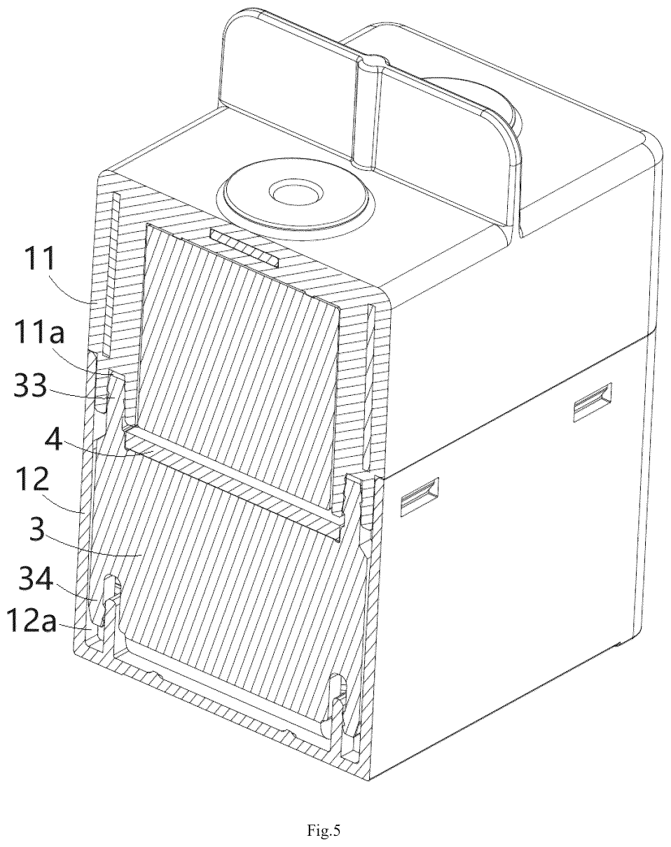

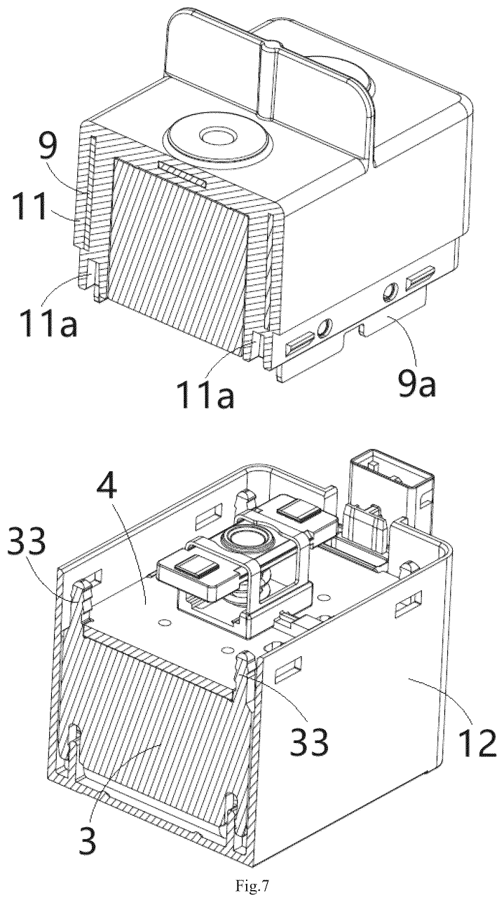

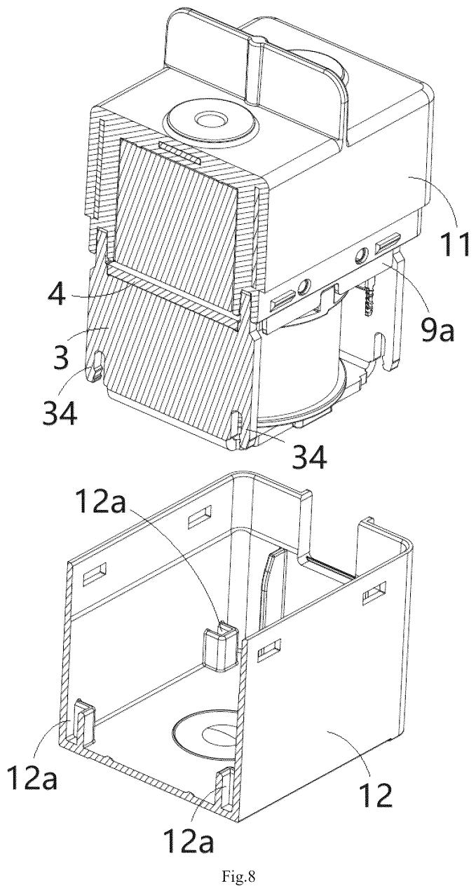

As shown in FIGS. 3-4, the upper buckle structure 35 includes an upper pin 33, which is used to plug into an upper slot 11a, as shown in FIGS. 5 and 7, of the upper housing 11 of the contactor. The lower buckle structure 36, as shown in FIGS. 3-4, includes a lower pin 34, which is used to plug into a lower slot 12a, as shown in FIGS. 5 and 8, of the lower housing 12 of the contactor.

As shown in FIG. 4, the bottom plate 32 extends along the mutually perpendicular first direction X and second direction Y, and the side plate 31 extends along the first direction X and the third direction (height direction) Z perpendicular to the first direction X and second direction Y. The side plate 31 has left and right opposite sides in the first direction X. An upper pin 33 is formed on each of the left and right sides of the upper part of the side plate 31, and a lower pin 34 is formed on each of the left and right sides of the lower part of the side plate 31.

As shown in FIG. 4, the width of the side plate 31 in the first direction X is greater than the width of the bottom plate 32 in the first direction X. One end of the bottom plate 32 is located between the two lower pins 34 of one side plate 31, and the other end of the bottom plate 32 is located between the two lower pins 34 of the other side plate 31.

As shown in FIGS. 3-4, an upper barb 33a is formed on the upper pin 33, which is suitable for interference fit with the inner wall of the upper slot 11a of the upper housing 11 to fix the upper pin 33 to the upper slot 11a and prevent it from being pulled out of the upper slot 11a. A lower barb 34a, as shown in FIGS. 3-4, is formed on the lower pin 34, which is suitable for interference fit with the inner wall of the lower slot 12a of the lower housing 12 to fix the lower pin 34 to the lower slot 12a and prevent it from being pulled out of the lower slot 12a.

As shown in FIGS. 3-4, multiple upper barbs 33a are formed on the upper pin 33, and the multiple upper barbs 33a are distributed at intervals in the extension direction (height direction) of the upper pin 33. Multiple lower barbs 34a, as shown in FIGS. 3-4, are formed on the lower pin 34, and the multiple lower barbs 34a are distributed at intervals in the extension direction (height direction) of the lower pin 34.

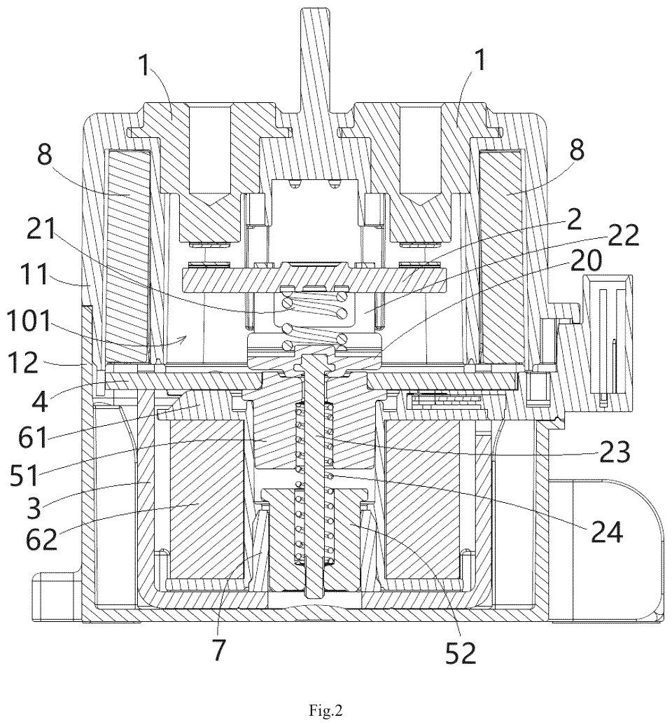

An exemplary embodiment of a contactor will now be described with reference to FIGS. 1-8. The contactor includes a housing, the contactor yoke 3, and the magnetic plate 4. As shown in FIGS. 1-2 and 5, the housing includes the upper housing 11 and the lower housing 12 assembled together. The contactor yoke 3 is located in the lower housing 12, as shown in FIGS. 2, 5, and 7. The magnetic plate 4 is set in the lower housing 12 and supported on the top surface of the pair of side plates 31 of the contactor yoke 3. The upper buckle structure 35 of the contactor yoke 3 is buckled to the upper housing 11 to fix the contactor yoke 3 and the magnetic plate 4 together to the upper housing 11. The lower buckle structure 36 of the contactor yoke 3 is buckled to the lower housing 12 to fix the contactor yoke 3 to the lower housing 12.

As shown in FIG. 5, the upper slot 11a is formed in the upper housing 11, and the upper pin 33 of the contactor yoke 3 is inserted into the upper slot 11a to fix the contactor yoke 3 and the magnetic plate 4 together to the upper housing 11. As further shown in FIG. 5, the lower slot 12a is formed in the lower housing 12, and the lower pin 34 of the contactor yoke 3 is inserted into the lower slot 12a to fix the contactor yoke 3 to the lower housing 12.

As shown in FIG. 3, the magnetic plate 4 is opposite to the bottom plate 32 of the contactor yoke 3, and the two ends of the magnetic plate 4 are respectively supported on the top surfaces of the pair of side plates 31 of the contactor yoke 3. One end of the magnetic plate 4 is located between the two upper pins 33 of one side plate 31 of the contactor yoke 3, and the other end of the magnetic plate 4 is located between the two upper pins 33 of the other side plate 31 of the contactor yoke 3.

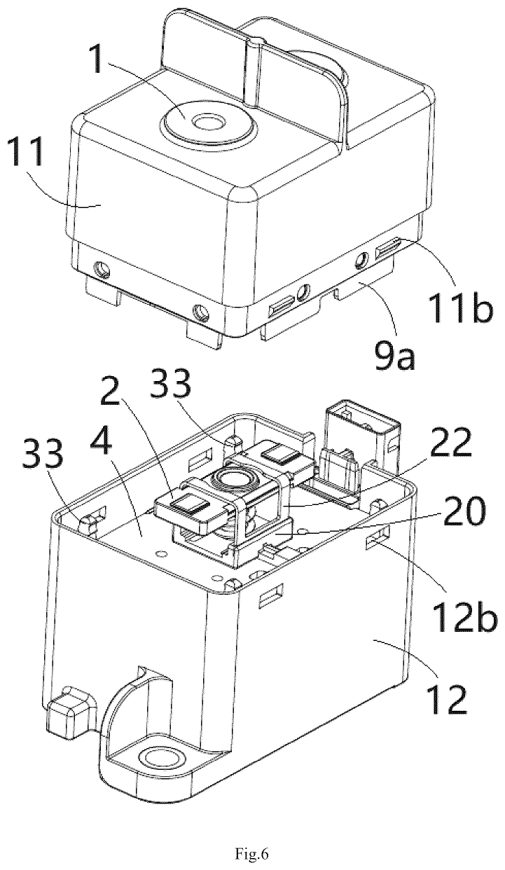

As shown in FIG. 5, the lower part of the upper housing 11 is inserted into the upper opening of the lower housing 12. As shown in FIG. 6, multiple protrusions 11b with spaced distribution are formed on the lower peripheral wall 9a of the upper housing 11, and multiple snap slots 12b with spaced distribution are formed on the upper peripheral wall of the lower housing 12. The multiple protrusions 11b are respectively engaged with the multiple snap slots 12b to fix the upper housing 11 and the lower housing 12 together.

As shown in FIG. 7, the contactor further comprises a shielding shell 9. The upper housing 11 is injection molded onto the shielding shell 9 through an embedded injection molding process, so that the shielding shell 9 is embedded into the upper housing 11. The shielding shell 9 has the lower peripheral wall 9a, as shown in FIGS. 7-8, extending from the lower end of the upper housing 11. The lower peripheral wall 9a of the shielding shell 9 is in electrical contact with the circumferential surface of the magnetic plate 4.

The contactor further includes a pair of static terminals 1, as shown in FIGS. 1-2 and 6, and a movable terminal 2, as shown in FIGS. 2 and 6. The pair of static terminals 1 are fixed to the top wall of the upper housing 11 and extend into an arc extinguishing chamber 101, as shown in FIG. 2, of the upper housing 11. The movable terminal 2 is set in the arc extinguishing chamber 101 of the upper housing 11, and can be moved between a closed position in electrical contact with the pair of static terminals 1 and an open position in electrical separation from the pair of static terminals 1.

As shown in FIG. 2, the contactor further comprises a pair of magnetic blowing magnets 8. The pair of magnetic blowing magnets 8 are embedded in the peripheral wall of the upper housing 11 and adjacent to the pair of static terminals 1, respectively. The pair of magnetic blowing magnets 8 are suitable for extinguishing the electric arc between the movable terminal 2 and the static terminal 1 through magnetic blowing.

As shown in FIG. 2, the contactor further comprises an insulation base 20, a contact spring 21, and a limit bracket 22. The insulation base 20 is located in the arc extinguishing chamber 101 of the upper housing 11. The contact spring 21 is compressed between the movable terminal 2 and the insulation base 20, and is used to apply contact pressure to the movable terminal 2. The limit bracket 22 is fixed to the insulation base 20 to restrict the direction and distance of movement of the movable terminal 2 relative to the insulation base 20.

The contactor further comprises a coil assembly, which is arranged in the contactor yoke 3. As shown in FIG. 2, the coil assembly includes a coil skeleton 61 and a coil 62 wound around the coil skeleton 61. The bottom of the coil skeleton 61 is supported on the bottom plate 32 of the contactor yoke 3, and the magnetic plate 4 is located above the top of the coil skeleton 61.

As shown in FIG. 2, the contactor further includes a drive shaft 23. The drive shaft 23 is set in the coil skeleton 61 and its upper end passes through the magnetic plate 4 and extends into the arc extinguishing chamber 101. The upper end of the drive shaft 23 is fixed to the insulation base 20, which electrically isolates the upper end of the drive shaft 23 from the contact spring 21 and the limit bracket 22.

The insulation base 20 is directly injection molded onto the drive shaft 23 and the limit bracket 22 through embedded injection molding, making the insulation base 20, drive shaft 23, and limit bracket 22 an integrated piece.

As shown in FIG. 2, the contactor further comprises a static magnetic core 51 and a movable magnetic core 52. The static magnetic core 51 is located in the coil skeleton 61 and fixed to the magnetic plate 4. The movable magnetic core 52 is arranged in a movable manner in the coil skeleton 61, and can be moved along its axial direction. The drive shaft 23 passes through the static magnetic core 51 and the movable magnetic core 52, and the lower end of the drive shaft 23 is connected to the movable magnetic core 52 to move together with it.

As shown in FIG. 2, the contactor further includes a reset spring 24, which is fitted on the drive shaft 23 and compressed between the static magnetic core 51 and the movable magnetic core 52. When the coil 62 is energized, the drive shaft 23 drives the movable terminal 2 from the open position to the closed position under the action of electromagnetic force. When the coil 62 loses power, the drive shaft 23 drives the movable terminal 2 from the closed position to the open position under the elastic reset force of the reset spring 24.

As shown in FIG. 2, the contactor further comprises a magnetic tube 7, which is fixed to the lower end of the coil skeleton 61. The bottom surface of the magnetic tube 7 is in contact with the bottom plate 32 of the contactor yoke 3, and the movable magnetic core 52 is set in the magnetic tube 7 in a movable manner.

The coil skeleton 61 is directly injection molded onto the magnetic tube 7 through embedded injection molding, making the coil skeleton 61 and the magnetic tube 7 an integrated piece.

In the aforementioned exemplary embodiments according to the present invention, the contactor yoke 3 is fixed to the upper housing 11 and the lower housing 12 by a snap fit method, simplifying the fixing process, reducing costs, improving production efficiency, and making the fixing of the contactor yoke 3 more reliable.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor yoke, comprising:
a pair of side plates each having an upper part and a lower part, each side plate has an upper buckle structure formed on the upper part and a lower buckle structure formed on the lower part; and
a bottom plate connected between a bottom of each of the pair of side plates, each upper buckle structure buckles onto an upper housing of a contactor to fix the contactor yoke and a magnetic plate of the contactor together to the upper housing, each lower buckle structure buckles to a lower housing of the contactor to fix the contactor yoke to the lower housing.

2. The contactor yoke of claim 1, wherein each upper buckle structure has an upper pin, each upper pin is inserted into one upper slot of the upper housing, and each lower buckle structure has a lower pin, the lower pin is inserted into one lower slot of the lower housing.

3. The contactor yoke of claim 2, wherein the bottom plate extends along a first direction and a second direction that are perpendicular to each other, each side plate extends along the first direction and a third direction that is perpendicular to the first direction and the second direction, each side plate has a left side and a right side opposite in the first direction, the upper pin is formed on each side of the upper part of each side plate, and the lower pin is formed on each side of the lower part of each side plate.

4. The contactor yoke of claim 3, wherein a width of each side plate in the first direction is greater than a width of the bottom plate in the first direction, one end of the bottom plate is located between two lower pins of one side plate, and another end of the bottom plate is located between two lower pins of another side plate.

5. The contactor yoke of claim 2, wherein an upper barb is formed on each upper pin, the upper barb is interference fit with an inner wall of one upper slot to fix the upper pin to the one upper slot and prevent the upper pin from being pulled out of the one upper slot, and/or a lower barb is formed on each lower pin, the lower barb is interference fit with an inner wall of one lower slot to fix the lower pin to the one lower slot and prevent the lower pin from being pulled out of the one lower slot.

6. The contactor yoke of claim 5, wherein:
a plurality of upper barbs are formed on each upper pin, the plurality of upper barbs are distributed at intervals in an extension direction of the upper pin, and/or
a plurality of lower barbs are formed on each lower pin, the plurality of lower barbs are distributed at intervals in an extension direction of the lower pin.

7. A contactor, comprising:
a housing including an upper housing and a lower housing assembled together;
a contactor yoke including a pair of side plates each having an upper part and a lower part, and a bottom plate, each side plate has an upper buckle structure formed on the upper part of each side plate and a lower buckle structure formed on the lower part of each side plate, the bottom plate is connected between a bottom of each of the pair of side plates, the contactor yoke is provided in the lower housing; and
a magnetic plate installed in the lower housing and supported on a top surface of each of the pair of side plates, each upper buckle structure buckles onto the upper housing to fix the contactor yoke and the magnetic plate together to the upper housing, each lower buckle structure buckles to the lower housing to fix the contactor yoke to the lower housing.

8. The contactor of claim 7, wherein an upper slot is formed in the upper housing, an upper pin of the contactor yoke is inserted into the upper slot to fix the contactor yoke and the magnetic plate together to the upper housing, and a lower slot is formed in the lower housing, a lower pin of the contactor yoke is inserted into the lower slot to fix the contactor yoke to the lower housing.

9. The contactor of claim 8, wherein the magnetic plate is opposite to the bottom plate, and both ends of the magnetic plate are supported on the top surface of each side plate, one end of the magnetic plate is located between two upper pins of one side plate, and another end of the magnetic plate is located between two upper pins of another side plate.

10. The contactor of claim 8, wherein a lower part of the upper housing is inserted into an upper opening of the lower housing, and a plurality of protrusions with spaced distribution are formed on a lower peripheral wall of the upper housing, a plurality of snap slots with spaced distribution are formed on an upper peripheral wall of the lower housing, each protrusion is engaged with one snap slot to fix the upper housing and the lower housing together.

11. The contactor of claim 8, further comprising a shielding shell, the upper housing is injection molded onto the shielding shell through an embedding injection molding process, such that the shielding shell is embedded into the upper housing, the shielding shell has a lower peripheral wall extending from a lower end of the upper housing, the lower peripheral wall is in electrical contact with a circumferential surface of the magnetic plate.

12. The contactor of claim 8, further comprising a pair of static terminals each fixed to a top wall of the upper housing and extending into an arc extinguishing chamber of the upper housing, and a movable terminal provided in the arc extinguishing chamber, the movable terminal is movable between a closed position in electrical contact with the pair of static terminals and an open position in electrical separation from the pair of static terminals.

13. The contactor of claim 12, further comprising a pair of magnetic blowing magnets each embedded in a peripheral wall of the upper housing and each adjacent to one of the pair of static terminals, the pair of magnetic blowing magnets extinguish an arc between the movable terminal and the pair of static terminals through magnetic blowing.

14. The contactor of claim 12, further comprising an insulation base located in the arc extinguishing chamber, a contact spring compressed between the movable terminal and the insulation base applies a contact pressure to the movable terminal, and a limit bracket fixed to the insulation base restricts a direction and a distance of movement of the movable terminal relative to the insulation base.

15. The contactor of claim 14, further comprising a coil assembly provided in the contactor yoke, the coil assembly includes a coil skeleton and a coil wound around the coil skeleton, a bottom of the coil skeleton is supported on the bottom plate, the magnetic plate is located above a top of the coil skeleton.

16. The contactor of claim 15, further comprising a drive shaft provided in the coil skeleton, an upper end of the drive shaft passes through the magnetic plate and extends into the arc extinguishing chamber, the upper end of the drive shaft is fixed to the insulation base, the insulation base electrically isolates the upper end of the drive shaft from the contact spring and the limit bracket.

17. The contactor of claim 16, wherein the insulation base is directly injection molded onto the drive shaft and the limit bracket through embedded injection molding, such that the insulation base, the drive shaft, and the limit bracket are an integrated piece.

18. The contactor of claim 16, further comprising a static magnetic core located in the coil skeleton and fixed to the magnetic plate, and a movable magnetic core arranged in the coil skeleton and movable along an axial direction of the coil skeleton, the drive shaft passes through the static magnetic core and the movable magnetic core, a lower end of the drive shaft is connected to the movable magnetic core to move together with the movable magnetic core.

19. The contactor of claim 18, further comprising a reset spring fitted onto the drive shaft and compressed between the static magnetic core and the movable magnetic core, when the coil is energized, the drive shaft drives the movable terminal to move from the open position to the closed position under an action of electromagnetic force, when the coil loses power, the drive shaft drives the movable terminal to move from the closed position to the open position under an elastic reset force of the reset spring.

20. The contactor of claim 18, further comprising a magnetic tube fixed into a lower end of the coil skeleton, a bottom surface of the magnetic tube is in contact with the bottom plate, the movable magnetic core is movable in the magnetic tube.

21. The contactor of claim 20, wherein the coil skeleton is directly injection molded onto the magnetic tube through embedded injection molding, such that the coil skeleton and the magnetic tube are an integrated piece.
